(19) United States
(12) Patent Application Publication
(10) Pub. No.: US 2002/0073230 A1
(43) Pub. Date: Jun. 13, 2002

(54) Method for transmitting data between a first and a second computing unit

(76) Inventor: Edelbert Konig, Kronau (DE)

Correspondence Address: LERNER AND GREENBERG, P. A., Post Office Box 2480, Hollywood, FL, 33022-2480, US

(21) Appl. No.: 09/981,847

(22) Filed: Oct. 18, 2001

(30) Foreign Application Priority Data
Oct. 18, 2000 (DE) 100 51 535.5

(51) Int. Cl. G06F 15/16

(52) U.S. Cl. 709/237; 709/227

(57) ABSTRACT

A method for establishing a data connection and for transmitting data from a first computing unit to a second computing unit, includes, in the first computing unit, selecting and reading out from a database an address of the second computing unit in a selection program; establishing a connection with the address of the second computing unit; initially performing a version comparison between the first and the second computing units with respect to an employed communications protocol; and, after the communications protocol is determined, establishing a data connection for transmitting data; and a computing unit with a memory for performing the method.

### BACKGROUND OF THE INVENTION

Field of the Invention

The invention relates to a method for transmitting data between two computing units.

Many methods are known for transmitting data between two computing units. For example, data are exchanged between two computing units over the Internet. It has also become known heretofore for data to be exchanged between two modems via a direct data connection. In the use of modems via a direct data connection or in a data exchange over the Internet, it is necessary for both computing units to output the data and receive it by a predetermined communications protocol. This requires that before the data connection is established, one computing unit knows which communications protocol the second computing unit is using. This causes the heretofore known method to be relatively inflexible.

### SUMMARY OF THE INVENTION

It is accordingly an object of the invention to provide a flexible method for transmitting data between a first and a second computing unit.

With the foregoing and other objects in view, there is provided, in accordance with one aspect of the invention, a method for establishing a data connection and for transmitting data from a first computing unit to a second computing unit, which comprises, in the first computing unit, selecting and reading out from a database an address of the second computing unit in a selection program; establishing a connection with the address of the second computing unit; initially performing a version comparison between the first and the second computing units with respect to an employed communications protocol; and, after the communications protocol is determined, establishing a data connection for transmitting data.

In accordance with another mode, the method of the invention includes displaying a specified number of diagnostic programs; selecting and starting one of the diagnostic programs via the first computing unit; and transmitting results of the one diagnostic program to the first computing unit.

In accordance with another mode, the method of the invention includes displaying a specified number of diagnostic programs for monitoring a printing press connected to the second computing unit; selecting and starting one of the diagnostic programs via the first computing unit; and transmitting results of the one diagnostic program to the first computing unit.

In accordance with a further mode, the method of the invention includes providing a table wherein diagnostic programs are assigned to specified printing presses, so that when establishing a connection, the diagnostic programs pertaining to a printing press are displayed for selection.

In accordance with an added mode, the method of the invention includes, depending upon the diagnostic program that is selected, establishing a communications protocol via which data are transmitted between the first and the second computing units.

In accordance with an additional mode, the method of the invention includes, depending upon the diagnostic program that is selected, providing a specified number of data ports via which data are transmitted.

In accordance with yet another mode, the method of the invention includes transmitting specified data only via specified data ports.

In accordance with yet a further mode, the method of the invention includes outputting the data in parallel via the data ports, and transmitting the data output serially in data packets via the data connection.

In accordance with yet an added mode, the method of the invention includes providing in each data packet an identifier for the data port, which indicates the data port from which the data were output.

In accordance with yet an additional mode, the method of the invention includes selecting a type of control with which the printing press is controlled by the computing unit and, depending upon the control that is selected, selecting at least one of a communications protocol and a diagnostic program.

In accordance with a concomitant mode, the method of the invention includes selecting a type of control with which the printing press is controlled by the computing unit and, depending upon the control that is selected, displaying at least one of a communications protocol and a diagnostic program for selection.

In accordance with another aspect of the invention, there is provided a computing unit with a memory, comprising at least one of hardware and software for selecting and reading out from a database an address of another computing unit in a selection program, for establishing a connection with the address of the other computing unit, for initially performing a version comparison between the computing units with respect to an employed communications protocol, and for establishing, after the communications protocol is determined, a data connection for transmitting data.

A considerable advantage of the invention is that before a data connection is established, the two computing units establish a connection with one another and agree on one of a plurality of possible communications protocols. Proceeding in this way offers the advantage that there is no need to specify in advance which communications protocol will be used to exchange the data. In this way, flexible data exchange between arbitrary computing units is possible.

Preferably provided are an assumed number of diagnostic programs for monitoring a printing press, which are executable for monitoring the printing press. Thus, the first computing unit has the capability of selecting a diagnostic program that is optimal for the information that is required.

In a preferred embodiment, depending upon the diagnostic program that is selected, a communications protocol is specified, by which data are transmitted between the first and the second computing units. Proceeding in this manner offers the advantage that the communications protocol for the selected diagnostic program is specified, and thus, for example, an optimal communications protocol for the data to be transmitted by that diagnostic program is selected.

In a further development of the invention, for the purpose of outputting the data, a predetermined number of data ports is specified, by which the data are output in parallel. The data being output in parallel are then transmitted serially. For unambiguous recognition of the data, the second computing unit has to know how many data ports there are. By the use of data ports, the data can be outputted quickly in parallel and then transmitted serially.

A refinement of the invention provides that, in the selection program, the type of control by which the printing press is triggered by the computing unit is selected. In this way, a precise determination of the diagnostic programs used for a diagnosis is possible.

Other features which are considered as characteristic for the invention are set forth in the appended claims.

Although the invention is illustrated and described herein as a method for transmitting data between a first and a second computing unit, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings, wherein:

### BRIEF DESCRIPTION OF THE DRAWINGS

FIG. 1 is a block schematic diagram of a first computing unit which communicates with a second computing unit via a data connection, the second computing unit being connected to a printing press;

FIG. 2 is a schematic diagram, somewhat in block form, illustrating a program structure by which data are exchanged between two computing units;

FIG. 3 is a block schematic diagram illustrating a method for defining a data-exchanging method; and

FIG. 4 is a block schematic diagram illustrating a method for exchanging data.

### DESCRIPTION OF THE PREFERRED EMBODIMENTS

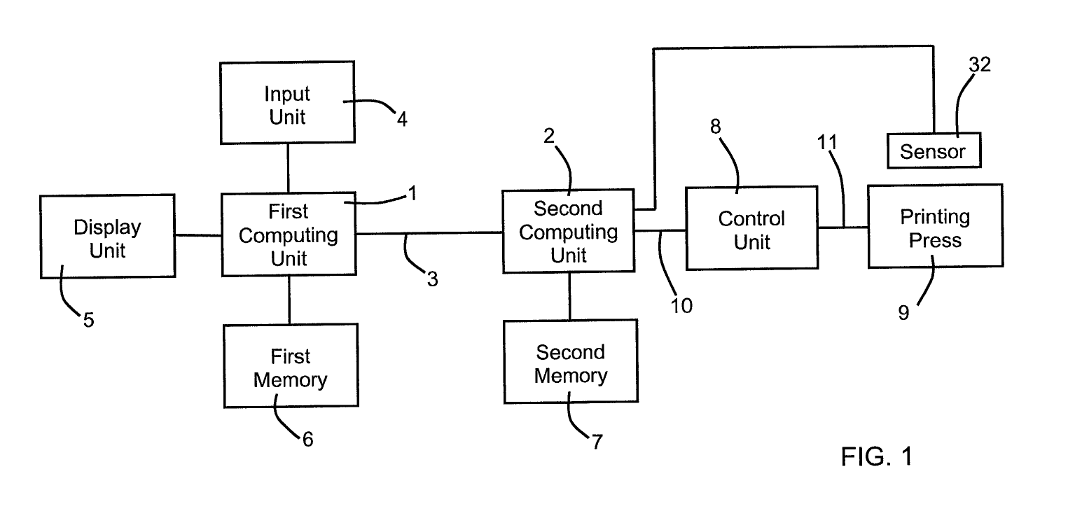

Referring now to the drawings and, first, particularly to FIG. 1 thereof, there is shown therein a first computing unit 1, which has an input unit 4, a display unit 5, and a first memory 6. The first computing unit 1 communicates with a second computing unit 2 via a data connection 3. The second computing unit 2 is in communication with both a second memory 7 and, via data lines 10, a control unit 8. The control unit 8 is connected to a printing press 9 via a control line 11. The second computing unit 2 and the control unit 8 control the printing press 9 in accordance with predetermined methods and data that are stored in the second memory 7. The printing press 9 is a sheet-fed printing press, for example. The second computing unit 2 is connected to a sensor 32, which is disposed on the printing press 9 and detects operating parameters of the printing press 9.

The data connection 3 is preferably constructed in the form of a point-to-point connection wherein, directly over a telephone line, a connection is established between the first and the second computing units 1 and 2. The direct data connection offers the advantage that the data are transmitted relatively reliably between the first and the second computing units 1 and 2.

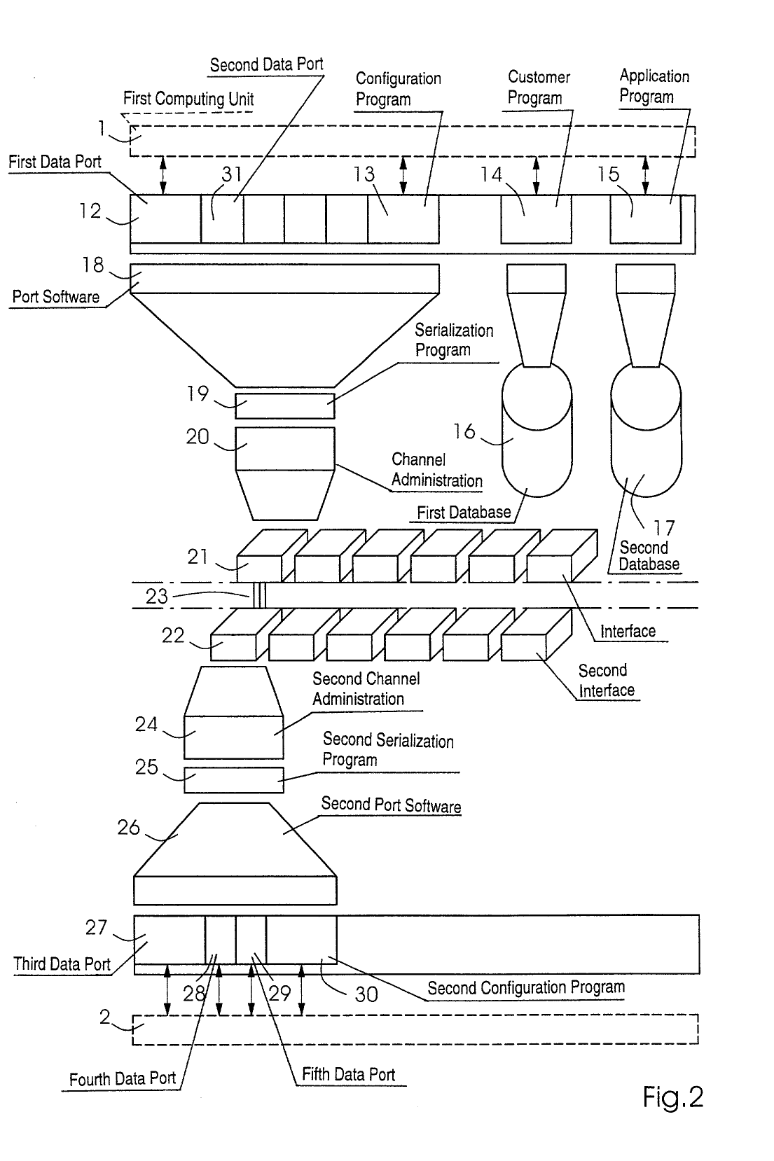

FIG. 2 schematically illustrates cooperation among various software programs and hardware components. The first computing unit 1, which is located, for example, in Heidelberg, is shown in the upper region. The first computing unit 1 is connected to a first data port 12 and a second data port 31. The first and the second data ports 12 and 31 are preferably realized in the form of software; the first and second data ports 12 and 31 are formed as port numbers in the data transmission, and each data packet that is transmitted has a port number in a data header. Thus, the data packets are assigned to predetermined data ports. In this manner, one can precisely determine that a datum originates in the first or the second data port.

The first computing unit 1 also has a configuration program 13, a customer program 14, and an application program 15. Via the configuration program 13, the first computing unit 1 is in communication with a first database 16, wherein the parameters required for the configuration are stored in memory. The first computing unit 1 is also in communication, via the application program 15, with a second database 17, wherein the parameters specified in the application program are stored in memory. The first and second databases 16 and 17 are stored in the first memory 6.

The first data port 12 is embodied as a TCP/IP port and is in communication with a port software 18, by which the data conducted from or to the first data port 12 are fed to a serialization program 19. The serialization program 19 is in communication with a channel administration 20.

Depending upon the setting, the channel administration 20 is connected to one of the possible interfaces 21. For example, an analog interface, an ISDN interface, an ethernet interface, a COM interface, or a USB interface is provided as the interface 21.

The port software 18 and the serialization program 19 convert the data, delivered in parallel via the data ports 12 and 31, into a serial data stream, wherein the data from a data port are transmitted in the form of data packets. The channel administration 20 converts the serial data, which are made available by the serialization program 19, into a data protocol that is equivalent to the chosen interface 21.

A dial-up connection 23 is provided between the interface 21 and a second interface 22.

The second interface 22 is in communication with a second channel administration 24 which, in turn, is in communication with a second serialization program 25. The second serialization program 25 is connected to a second port software 26, which is connected to a third, fourth and fifth data port 27, 28, 29, respectively. A second configuration program 30 is also in communication with the second port software 26. The third, fourth and fifth data ports 27, 28 and 29 and the second configuration program 30 are in communication with the second computing unit 2.

Through the intermediary of the customer program 14, by suitable inputting via the input 4, various customers and the printing presses thereof, respectively, can be set up. The inputs are stored in memory in the first database 16.

For the applicable customer and printing press, respectively, the following parameters, for example, can be set: machine number; name of the customer; country in which the printing press is operated wherein, depending upon the country, the country code for telephone connection is chosen from an appropriate database; the telephone number of a modem with which a telephone connection with the second computing unit can be established; the TCP/IP address at which the second computing unit can be reached; an assignment of the control used in the printing press and, optionally, when the control is mounted on a basic computer printed circuit board, an indication of the type of printing press.

Furthermore, the customer and the applicable printing press, respectively, can be selected via the customer program 14. After the selection, the actual connection can be initiated with a login. With a logout and exit, respectively, the connection can be broken and the application closed, respectively. For example, the following further elements can be set or selected: a customer list, which includes important information for each customer and/or each printing press; the type of connection with which a data connection to the applicable customer and applicable printing press, respectively, is established; the country-specific code for the country wherein the printing press is located; and an assignment of a control to the printing press.

In addition, via the application program 15, a determination or selection of various applications can be set up, which are displayed on the display 5 after the connection has been established. For example, Telnet, which enables access to the second computing unit 2 in the form of a terminal session, is used as the applications software. In this regard, a bidirectional, transparent, character-oriented connection is established between the first and second computing units 1 and 2. The communication between the first and the second computing units 1 and 2 is effected based upon a network virtual terminal (NVT).

The inputs which are specified during the application program are stored in memory in the second database 17. As a rule, these are applications with which it is possible to display the operating states of the printing press. Thus, the operating parameters of the printing press that are asked for online are shown on the display 5 of the first computing unit 1. For the desired application, the following parameters, for example, can be set: assignment to the applicable printing press control, such as the conventional controls CP2000, CPTronic/RGP2, or CPTronic/RGP3, a selection of the transfer parameters in the execution of diagnostic programs, a display of the diagnostic program version that is used, and the display of a button that automatically displays the connection structure on the display 5.

Via the configuration program 13, when a data connection is established between the first and the second computing units 1 and 2, a specific data configuration, by which the communication channel between the first and the second computing units 1 and 2 is constructed, is selected in cooperation with the second configuration program 30.

In this regard, the type of connection can be set, for example, in accordance with the following parameters: CAPI driver (ISDN connection via ISDN card); COM (serial interface via COMn); modem (analog—or ISDN modem via COMn); TCP/IP (via TCP/IP address); dialing method (tone or pulse); direct dial without area code; area code preceded by 0; COM port (COM output used); timeout, which indicates the period of time within which a data connection is disconnected if no data connection is established; Initstring (initialization string for modem); server/client setting, which indicates the mode in which the ACM is to be operated; CP2000 pipe mode (internal construction of pipes for CPTronic/CP2000 machines); log file transport (button for log file dialog becomes visible in the connection region); database paths (setting of the applicable application and machine database, respectively).

The parameters given above describe the kind of communications exchange between the first and the second computing units 1 and 2 and, thus, for example, establish which first and second interface 21 and 22 will be chosen for the data exchange. The first configuration program 13 thus sets the first interface 21, and the second configuration program 30 sets the second interface 22.

The first, second, third and fourth data ports 12, 31, 27, 28, 29 represent defined interfaces, via which data are exchanged by a specified TCP/IP data protocol. In this regard, at the data ports, the data are furnished in the form of a data set of specified structure, and a port number for the data port from which the data originate is stored in the data header. Consequently, the data sets, which are preferably output in the form of data packets, should be unambiguously assigned to a data port. The data output in parallel from the data ports are converted in the outputting process into a serial data stream via the first or the second serialization program 19, 25. Next, the serial data stream is converted by the first and the second channel administration 20, 24, respectively, in accordance with the chosen configuration, into a corresponding physical data channel and are transmitted via the selected first or second interface 21, 22 to the dial-up connection 23.

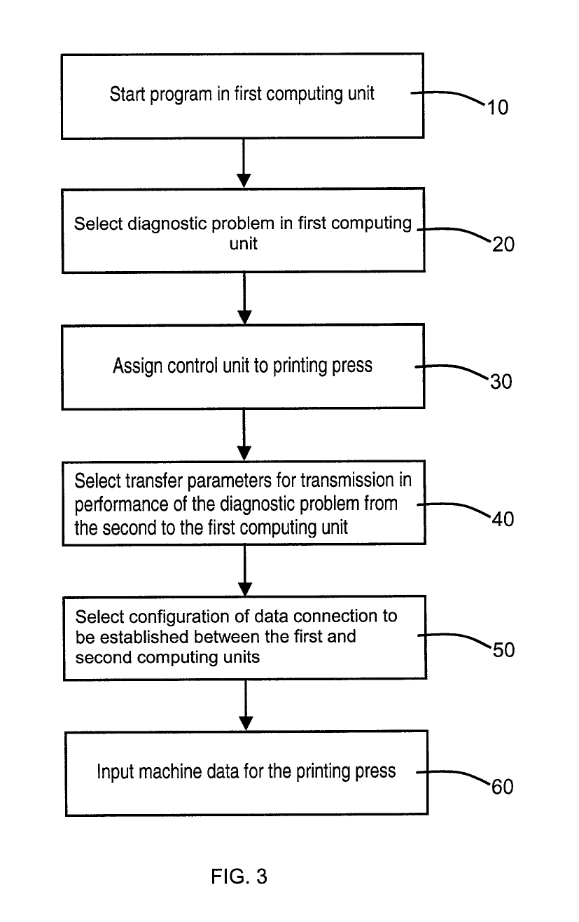

FIG. 3 illustrates a method for setting a data connection between the first and the second computing units 1 and 2. At a program point 10, the program is started in the first computing unit 1. Next, at a program point 20, a selection of one among a plurality of diagnostic programs is made in the first computing unit 1. At a next program point 30, a control unit is assigned to the printing press to be monitored. Next, at a program point 40, a selection of the transfer parameters is specified, which are to be transmitted in the performance of the diagnostic program from the second computing unit 2 to the first computing unit 1. Next, at a program point 50, a configuration of the data connection is selected, according to which a connection is to be established between the first or second computing unit 1, 2. At a next program point 60, machine data for the printing press to be monitored are preferably input. After the described program steps have been executed, an initialization of the data connection between the first and the second computing units is performed.

For example, by selecting the transfer parameters at the program point 40, the data ports via which the data are read out are simultaneously specified. Furthermore, via the definition of the configuration, one of the possible interfaces 21 and 22 is selected in order to establish the data connection via the dial-up connection 23.

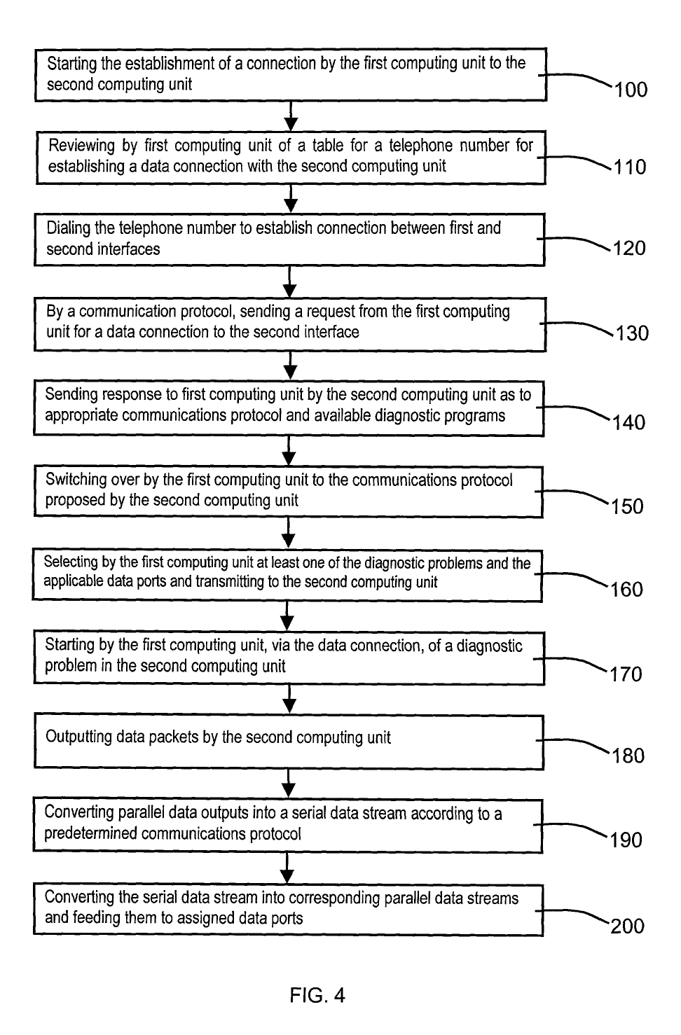

The establishment of a data connection between the first and the second computing units 1 and 2 is described hereinafter in further detail in conjunction with FIGS. 4 and 2. At a program point 100, the first computing unit 1, after a login input via the input 4, starts the establishment of a connection to a previously specified second computing unit, which was selected in accordance with the method illustrated in FIG. 3. At a next program point 110, the first computing unit 1 looks in a table for the telephone number by which a data connection with the selected second computing unit can be established. Next, at program point 120, the first computing unit 1 dials the applicable telephone number, so that a data connection is established between the specified first interface 21 and the specified second interface 22. Next, at a program point 130, by a communications protocol specified as above, the first computing unit 1 sends a request for a data connection to the specified second interface 22. The second interface 22, via the second channel administration 24 and the second serialization program 25, transfers the request signal to the second port software 26, which sends the request on to a specified data port 27, 28, 29.

Once the request has been received, the second computing unit 2, by the specified communications protocol, sends a response at a program point 140 to the first computing unit 1, which response indicates which communications protocol will be used for data exchange, and which diagnostic programs are available for monitoring the printing press 9. The diagnostic programs are stored in the second memory 7.

Once the response has been received from the second computing unit 2, the first computing unit 1 at a program point 150 switches over to the communications protocol proposed by the second computing unit 2 and then, at a program point 160, selects at least one of the possible diagnostic programs and the applicable data ports. This information is transmitted to the second computing unit 2.

At a next program point 170, the first computing unit 1, by issuing a suitable start signal via the data connection 3, starts the execution of a diagnostic program in the second computing unit 2. In the execution of the diagnostic program, the second computing unit 2 accesses data of the control unit 8 and/or data of the printing press 9. The data of the printing press 9 are furnished via a sensor 32 to the second computing unit 2, which furnishes information on various operating parameters of the printing press 9 to the second computing unit 2. The data are transmitted in the form of data packets, with a data header and useful data. The data header includes information about which data port has output the data packet and what type of data is involved. The type of data indicates, for example, what parameters of the printing press are involved. The assignment of the data packet to a data port is effected via a port number.

The data packets are output at a program point 180 by the second computing unit 2, preferably separably depending upon the data, via the third, fourth or fifth data port 27, 28, 29. For example, service data, such as data about a dynamic test of the control unit 8 or data about a test of the second memory 7, are established at the third data port 27 and are output only via the third data port 27. Job-relevant data are output, for example, via the fourth data port 28. Setting values, such as the number of printing values, the type of delivery, and so forth, are output, for example, via the third data port 29. Application data, such as a color zone setting or a quantity of dampening medium, for example, are also output via a separate data port. A plurality of data ports are therefore required, to enable an exchange of different types of data simultaneously.

At a program point 190 (note FIG. 4), the data output in parallel via the third, fourth and fifth data ports 27, 28 and 29 are converted by the second port software 26 and the second serialization program 25 into a serial data stream in accordance with a predetermined communications protocol. The data are transported in the form of data packets by a time multiplexing process, and each data packet has a data header which indicates the data port from which the data originate, and the length of the data set.

At a program point 200, the serial data stream is converted by the first serialization program 19 and the first port software 18, based upon the identifier in the data header of the data packets, into corresponding parallel data streams, and fed to the assigned data ports 12 and 31.

A considerable advantage of the invention is that a so-called connection manager is provided between the data ports 12 and 31 of the first computing unit 1 and the data ports 27, 28 and 29 of the second computing unit 2; this connection manager enables an automatic configuration and a serialization of the data, which are output in parallel by the data ports, into a serial data stream. The diagnostic program for monitoring the control unit 8 and the printing press 9 runs independently of the connection manager, and the result is output via the corresponding data ports 27, 28 and 29. The data ports in the form of TCP/IP data ports represent a standardized interface, so that programming of the diagnostic programs and programming of the configuration programs is possible independently of the type of data transmission employed between the data ports. The programs can thus be written in accordance with specified methods. Hence, the type of data transmission need not be known to the programmer, making independent programming possible.

By using a port software 18, 26 and a serialization program 19, 25, a simple data exchange is enabled. Transmission of the data of the individual data ports in the form of data packets with a data header, in which an identifier for the data port by which the data are output is specified, is a simple, robust method for exchanging data via a dial-up connection 23 and suitably selected first and second interfaces 21 and 22. The conversion of the logical data stream into a physical data stream is effected via a channel administration 20, 24 and is thus once again independent of the conversion of the parallel data stream into a serial data stream. Data processing that is relatively simple and that can be monitored precisely is thus made possible. If errors occur, the individual data program segments can be monitored for correct functioning.

I claim:

1. A method for establishing a data connection and for transmitting data from a first computing unit to a second computing unit, which comprises, in the first computing unit, selecting and reading out from a database an address of the second computing unit in a selection program; establishing a connection with the address of the second computing unit; initially performing a version comparison between the first and the second computing units with respect to an employed communications protocol; and, after the communications protocol is determined, establishing a data connection for transmitting data.

2. The method according to claim 1, which includes displaying a specified number of diagnostic programs; selecting and starting one of the diagnostic programs via the first computing unit; and transmitting results of the one diagnostic program to the first computing unit.

3. The method according to claim 1, which includes displaying a specified number of diagnostic programs for monitoring a printing press connected to the second computing unit; selecting and starting one of the diagnostic programs via the first computing unit; and transmitting results of the one diagnostic program to the first computing unit.

4. The method according to claim 3, which includes providing a table wherein diagnostic programs are assigned to specified printing presses, so that when establishing a connection, the diagnostic programs pertaining to a printing press are displayed for selection.

5. The method according to claim 3, which includes, depending upon the diagnostic program that is selected, establishing a communications protocol via which data are transmitted between the first and the second computing units.

6. The method according to claim 3, which includes, depending upon the diagnostic program that is selected, providing a specified number of data ports via which data are transmitted.

7. The method according to claim 6, which includes transmitting specified data only via specified data ports.

8. The method according to claim 7, which includes outputting the data in parallel via the data ports, and transmitting the data output serially in data packets via the data connection.

9. The method according to claim 8, which includes providing in each data packet an identifier for the data port, which indicates the data port from which the data were output.

10. The method according to claim 1, which includes selecting a type of control with which the printing press is controlled by the computing unit and, depending upon the control that is selected, selecting at least one of a communications protocol and a diagnostic program.

11. The method according to claim 1, which includes selecting a type of control with which the printing press is controlled by the computing unit and, depending upon the control that is selected, displaying at least one of a communications protocol and a diagnostic program for selection.

12. A computing unit with a memory, comprising at least one of hardware and software for selecting and reading out from a database an address of another computing unit in a selection program, for establishing a connection with the address of the other computing unit, for initially performing a version comparison between the computing units with respect to an employed communications protocol, and for establishing, after the communications protocol is determined, a data connection for transmitting data.
